(19) United States
(12) Patent Application Publication
(10) Pub. No.: US 2013/0155012 A1
(43) Pub. Date: Jun. 20, 2013

(54) PATTERN OF TOUCH SCREEN

(71) Applicant: EGALAX_EMPIA TECHNOLOGY INC., Taipei City (TW)

(72) Inventor: CHIN-FU CHANG, TAIPEI CITY (TW)

(73) Assignee: EGALAX_EMPIA TECHNOLOGY INC., Taipei City (TW)

(21) Appl. No.: 13/714,523

(22) Filed: Dec. 14, 2012

Related U.S. Application Data
(60) Provisional application No. 61/577,181, filed on Dec. 19, 2011.

(51) Int. Cl. G06F 3/044

(52) U.S. Cl. CPC G06F 3/044
USPC 345/174

(57) ABSTRACT

A capacitive touch screen includes a plurality of first conductive strips and a plurality of second conductive strips. Each of the first and the second conductive strips includes a plurality of branches on at least one side thereof. The branches of the first conductive strips and the branches of the second conductive strips are distributed in the spaces of each other. The branches are bent in a clockwise direction and/or an anticlockwise direction.

### CROSS REFERENCE TO RELATED PATENT APPLICATION

This patent application claims the domestic priority of the U.S. provisional application 61/577,181 filed on Dec. 19, 2011, and hereby incorporated by reference.

### BACKGROUND OF THE INVENTION

1. Field of the Invention

The present invention relates to patterns of touch screens, and more particularly, to patterns of touch screens with branching conductive strips.

2. Description of the Prior Art

In the prior art, conductive strips on a touch screen are usually elongated strips or composed only of diamond-shaped conductive pads connected in series. The range covered by each conductive strip is limited, and distributions of signals are relatively not uniform. As a result, when an oblique line is drawn by a hand, the resulting line may exhibit saw-tooth features and does not closely match a smooth oblique line.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

In the prior art, signals are not so evenly distributed since the extent of coverage by the conventional conductive strips is somewhat limited. An objective of the present invention is to provide conductive strips with a plurality of bent branches, wherein the branches of the horizontal and vertical conductive strips are in interlaced distribution, resulting in more evenly distributed conductive strips.

The above and other objectives of the present invention can be achieved by the following technical scheme. The present invention proposes a capacitive touch screen, which may include: a plurality of first conductive strips, each of the first conductive strips including a plurality of branches on at least one side thereof, each branch including a plurality of bends in one of clockwise and anticlockwise directions; and a plurality of second conductive strips, each of the second conductive strips including a plurality of branches on at least one side thereof, each branch including a plurality of bends in one of clockwise and anticlockwise directions, wherein the branches of the first conductive strips and the branches of the second conductive strips are distributed within the spaces of each other and are both bent in the same direction.

The above and other objectives of the present invention can also be achieved by the following technical scheme. The present invention proposes a capacitive touch screen, which may include: a plurality of first conductive strips, each of the first conductive strips including a plurality of branches on at least one side thereof, each branch of the first conductive strips including a plurality of first branches and a plurality of second branches, each of the first branches including a plurality of bends in a clockwise direction and each of the second branches including a plurality of bends in an anticlockwise direction; and a plurality of second conductive strips, each of the second conductive strips including a plurality of branches on at least one side thereof, each branch of the second conductive strips including a plurality of first branches and a plurality of second branches, each of the first branches including a plurality of bends in the clockwise direction and each of the second branches including a plurality of bends in the anticlockwise direction, wherein the branches of the first conductive strips and the branches of the second conductive strips are distributed within the spaces of each other.

With the above technical schemes, the present invention achieve at least the following advantages and beneficial effects:

1. The branches of the conductive strips are in interlaced distribution, resulting in a larger area of coverage and a more uniform distribution.

2. The area of the conductive strips provided with the driving signals is larger that of the conductive strips providing the capacitive coupling signals, reducing the unreal-touch signals created as a result of the driving signal flowing into external conductive objects and back to the touch screen.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIGS. 1A to 1C are schematic diagrams depicting conductive strip patterns of a capacitive touch screen in accordance with a first embodiment of the present invention;

FIGS. 2A to 2C are schematic diagrams depicting conductive strip patterns of a capacitive touch screen in accordance with a second embodiment of the present invention; and

FIG. 3 is a schematic diagram depicting arc-shaped conductive strip patterns of a capacitive touch screen.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

In the mutual capacitive detection of a capacitive touch screen, a driving signal is sequentially provided to one of a plurality of driven conductive strips. When each driven conductive strip is being provided with the driving signal, one-dimensional (1D) sensing information corresponding to the conductive strip being provided with the driving signal is generated by signals of a plurality of detected conductive strips. The 1D sensing information corresponding to each of the conductive strips are combined together to form two-dimensional (2D) sensing information, which can be regarded as an image representing signals at the intersections of the driven conductive strips and the detected conductive strips.

An image detected when there is no touch on the capacitive touch screen is used as a reference. This reference is continuously compared to the detected images, so that the region or location of an external conductive object approaching or touching the capacitive touch screen can be determined based on the changes in the signal at each intersection.

When capacitive coupling is generated between a driven conductive strip and a detected conductive strip, a power line is formed between the two. Said changes in the signals are mainly caused by the fact that the power lines exceeding the capacitive touch screen are being shielded by the external conductive object. The more power lines exceeding the capacitive touch screen, the more likely the power lines are being shielded, and thus the greater the amount of signal changes. This results in a higher signal-to-noise ratio, rendering a more accurate detection result. Therefore, the more the driven conductive strips and the detected conductive strips are adjacent to each other, the more the power lines between them.

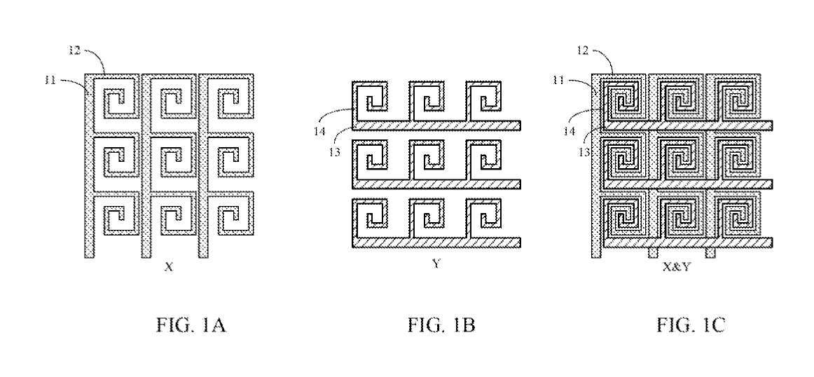

Referring now to FIGS. 1A to 1C, the structure of the conductive strips in a capacitive touch screen in accordance with a first embodiment of the present invention is shown. As shown in FIG. 1A, there are a plurality of first conductive strips 11 arranged in a first direction. There is a plurality of braches 12 extending from one end of each of the first conductive strips 11. Each branch 12 includes a plurality of bends in one of the clockwise and anticlockwise direction. Similarly, as shown in FIG. 1B, there is a plurality of second conductive strips 13 arranged in a second direction. There is a plurality of braches 14 extending from one end of each of the second conductive strips 13. Each branch 14 includes a plurality of bends in one of the clockwise and anticlockwise direction. The branches 12 of the first conductive strips 11 and the branches 14 of the second conductive strips 13 are bent in the same direction.

Furthermore, as shown in FIG. 1C, the branches 12 of the first conductive strips 11 and the branches 14 of the second conductive strips 13 are distributed within the spaces of each other. Apart from the intersections between the main bodies of the first conductive strips 11 and the second conductive strips 13, there is no intersection between the branches 12 and 14.

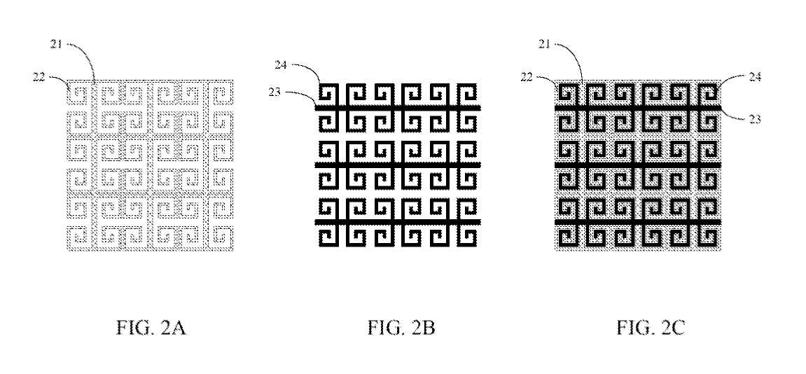

Referring now to FIGS. 2A to 2C, the structure of the conductive strips in a capacitive touch screen in accordance with a second embodiment of the present invention is shown. As shown in FIG. 2A, there are a plurality of first conductive strips 21 arranged in a first direction. There is a plurality of braches 22 extending from both ends of each of the first conductive strips 21. Each branch 22 includes a plurality of bends in one of the clockwise and anticlockwise direction. Similarly, as shown in FIG. 2B, there is a plurality of second conductive strips 23 arranged in a second direction. There is a plurality of braches 24 extending from both ends of each of the second conductive strips 23. Each branch 24 includes a plurality of bends in one of the clockwise and anticlockwise direction.

Furthermore, as shown in FIG. 2C, the branches 22 of the first conductive strips 21 and the branches 24 of the second conductive strips 23 are distributed within the spaces of each other. Apart from the intersections between the main bodies of the first conductive strips 21 and the second conductive strips 23, there is no intersection between the branches 22 and 24. In addition, the branches 22 and 24 distributed with the spaces of each other are bent in the same direction.

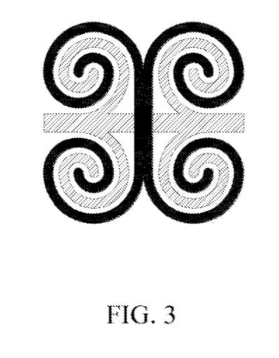

The bends in the first and second embodiments are not necessarily at right angles, but can be arc-shaped, as shown in FIG. 3.

Accordingly, the present invention proposes a capacitive touch screen, which includes a plurality of first conductive strips and a plurality of second conductive strips. Each of the first and second conductive strips includes a plurality of branches on at least one side thereof. The branches of the first and the second conductive strips are distributed within the spaces of each other.

In an example of the present invention, each of the first conductive strips includes a plurality of branches on at least one side thereof, and each branch includes a plurality of bends in the clockwise or the anticlockwise direction. Each of the second conductive strips includes a plurality of branches on at least one side thereof, and each branch includes a plurality of bends in the clockwise or anticlockwise direction, wherein the directions in which the branches of the first conductive strips and the branches of the second conductive strips are bent are the same.

In another example of the present invention, each of the first and second conductive strips includes a plurality of first branches and a plurality of second branches. Each first branch has a plurality of bends in the clockwise direction and each second branch has a plurality of bends in the anticlockwise direction.

Each branch of the first conductive strips bent in the clockwise direction is distributed in the space of one of the branches of the second conductive strips bent in the clockwise direction, and each branch of the first conductive strips bent in the anticlockwise direction is distributed in the space of one of the branches of the second conductive strips bent in the anticlockwise direction. Similarly, each branch of the second conductive strips bent in the clockwise direction is distributed in the space of one of the branches of the first conductive strips bent in the clockwise direction, and each branch of the second conductive strips bent in the anticlockwise direction is distributed in the space of one of the branches of the first conductive strips bent in the anticlockwise direction.

Moreover, the branches of the first conductive strips and the branches of the second conductive strips do not intersect with each other, and portions of the first conductive strips other than the branches and portions of the second conductive strips other than the branches intersect at a plurality of places.

In an example of the present invention, the bends are arc-shaped, so both the branches of the first conductive strips and the branches of the second conductive strips are spiral-shaped. In another example of the present invention, the bends are at right angle, and each branch is composed of a plurality of vertical branch segments and a plurality of horizontal branch segments connected in series, and the lengths of the branch segments oriented in the same direction in the same branch are all different. In other words, for two parallel branch segments in the same branch, the inner branch segment is shorter than the outer branch segment.

In addition, in mutual-capacitive detection, one of the first conductive strip and the second conductive strip is a driven conductive strip being provided with a driving signal, while the other one of the first conductive strip and the second conductive strip is a sensed conductive strip providing a capacitive coupling signal.

When fingers of a hand touches the touch screen, the driving signal may flow out of the touch screen into one finger, and then flow into the touch screen from another finger. This causes inversed signals, or unreal-touch signals, to be detected on the sensed conductive strips. The unreal-touch signals may cancel out the normal real-touch signals flowing out of the conductive strips, thus creating errors in detection.

In an example of the present invention, the first conductive strips are used as driven conductive strips. The total area of the first conductive strips is greater than that of the second conductive strips. At least one of the first conductive strips is provided with a driving signal during mutual-capacitive detection, and the second conductive strips provide capacitive coupling signals during mutual-capacitive detection.

In the first conductive strips, apart from the conductive strip(s) being provided with the driving signal (e.g. an AC signal), the rest of the first conductive strips are coupled to ground (e.g. a DC potential). As such, since the area of the first conductive strips is larger, implying that the area of conductive strips coupled to ground is larger, a larger proportion of the unreal-touch signals flowing into the touch screen will flow into ground, thereby reducing the effect of the unreal-touch signals.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A capacitive touch screen comprising:
a plurality of first conductive strips, each of the first conductive strips including a plurality of branches on at least one side thereof, each branch including a plurality of bends in one of clockwise and anticlockwise directions; and
a plurality of second conductive strips, each of the second conductive strips including a plurality of branches on at least one side thereof, each branch including a plurality of bends in one of clockwise and anticlockwise directions,
wherein the branches of the first conductive strips and the branches of the second conductive strips are distributed within the spaces of each other and are both bent in the same direction.

2. The capacitive touch screen of claim 1, wherein the branches of the first conductive strips and the branches of the second conductive strips do not intersect with each other, and portions of the first conductive strips other than the branches and portions of the second conductive strips other than the branches intersect at a plurality of places.

3. The capacitive touch screen of claim 1, wherein the bends are arc-shaped, so both the branches of the first and the second conductive strips are spiral-shaped.

4. The capacitive touch screen of claim 1, wherein the bends are at right angle, wherein each branch is composed of a plurality of vertical branch segments and a plurality of horizontal branch segments connected in series, and the lengths of the branch segments oriented in the same direction in the same branch are all different.

5. The capacitive touch screen of claim 4, wherein each branch of the first conductive strips bent in the clockwise direction is distributed in the space of one of the branches of the second conductive strips bent in the clockwise direction, and each branch of the first conductive strips bent in the anticlockwise direction is distributed in the space of one of the branches of the second conductive strips bent in the anticlockwise direction.

6. The capacitive touch screen of claim 1, wherein the total area of the first conductive strips is greater than that of the second conductive strips, wherein at least one of the first conductive strips is provided with a driving signal during mutual-capacitive detection, and the second conductive strips provide capacitive coupling signals during mutual-capacitive detection.

7. A capacitive touch screen comprising:
a plurality of first conductive strips, each of the first conductive strips including a plurality of branches on at least one side thereof, each branch of the first conductive strips including a plurality of first branches and a plurality of second branches, each of the first branches including a plurality of bends in a clockwise direction and each of the second branches including a plurality of bends in an anticlockwise direction; and
a plurality of second conductive strips, each of the second conductive strips including a plurality of branches on at least one side thereof, each branch of the second conductive strips including a plurality of first branches and a plurality of second branches, each of the first branches including a plurality of bends in the clockwise direction and each of the second branches including a plurality of bends in the anticlockwise direction,
wherein the branches of the first conductive strips and the branches of the second conductive strips are distributed within the spaces of each other.

8. The capacitive touch screen of claim 7, wherein the branches of the first conductive strips and the branches of the second conductive strips do not intersect with each other, and portions of the first conductive strips other than the branches and portions of the second conductive strips other than the branches intersect at a plurality of places.

9. The capacitive touch screen of claim 7, wherein the bends are arc-shaped, so both the branches of the first and the second conductive strips are spiral-shaped.

10. The capacitive touch screen of claim 7, wherein the bends are at right angle, wherein each branch is composed of a plurality of vertical branch segments and a plurality of horizontal branch segments connected in series, and the lengths of the branch segments oriented in the same direction in the same branch are all different.

11. The capacitive touch screen of claim 10, wherein each branch of the first conductive strips bent in the clockwise direction is distributed in the space of one of the branches of the second conductive strips bent in the clockwise direction, and each branch of the first conductive strips bent in the anticlockwise direction is distributed in the space of one of the branches of the second conductive strips bent in the anticlockwise direction.

12. The capacitive touch screen of claim 7, wherein the total area of the first conductive strips is greater than that of the second conductive strips, wherein at least one of the first conductive strips is provided with a driving signal during mutual-capacitive detection, and the second conductive strips provide capacitive coupling signals during mutual-capacitive detection.
